(19) United States
(12) Patent Application Publication
(10) Pub. No.: US 2026/0352322 A1
(43) Pub. Date: Nov. 5, 2026

(54) METHOD FOR EVALUATING THE RECEPTION QUALITY OF A NON-TERRESTRIAL NETWORK CONNECTION AND VEHICLE

(71) Applicant: MERCEDES-BENZ GROUP AG, Stuttgart (DE)

(72) Inventors: Osman AYDIN, Leinfelden-Echterdingen (DE); Musa CEYLAN, Böblingen (DE)

(21) Appl. No.: 19/484,579

(22) PCT Filed: Apr. 11, 2024
(86) PCT No.: PCT/EP2024/059760

§ 371 Date: Nov. 14, 2025

(30) Foreign Application Priority Data
May 15, 2023 (DE) 10 2023 001 970.4

(51) Int. Cl. H04B 7/185; H04W 4/38; H04W 4/40; H04W 36/30

(52) U.S. Cl. CPC H04B 7/18547; H04W 4/38; H04W 4/40; H04W 36/304

(57) ABSTRACT

Satellite properties of satellites participating in the non-terrestrial network are collected and the reception quality of a non-terrestrial network connection is evaluated. A current holding position of a vehicle is determined and satellite properties are determined or retrieved. The satellite properties orbital coordinates a satellite and beam parameters of the communication beam directed to Earth. The holding position of the vehicle is compared with the orbital coordinates of the satellite to determine a line of sight from the vehicle to one satellite. The surroundings are detected using a surroundings sensor and the extent of surroundings objects at least in the current detection region of the surroundings sensor is determined. An obstruction of the line of sight from the vehicle to the satellite is determined depending on the extent of surrounding objects located within the line of sight. The reception quality is evaluated inversely proportional to obstruction.

### BACKGROUND AND SUMMARY OF THE INVENTION

Exemplary embodiments of the invention relate to a method for evaluating the reception quality of a non-terrestrial network connection a vehicle performing the method.

Modern communication networks allow people to be reachable at all times. Mobile communications now also allow internet access on the go. Technologies based on mobile communications such as 2G, 3G, 4G, or 5G, as well as Wi-Fi networks, are also known as terrestrial networks (TN). Here, mobile devices such as laptops, tablet computers, smartphones, and the like are connected wirelessly to a Wi-Fi hotspot or a mobile network base station. The hotspot or the mobile network base station is in turn connected to the actual communications network via a cable. Wireless communication is only possible when the mobile device in question is within radio range of the hotspot or mobile network base station.

Furthermore, so-called non-terrestrial networks, also known as non-terrestrial networks (NTNs), are known. Here, the communication relay between a mobile terminal and the communication network do not serve as a ground-based transmitting/receiving station, but satellites. In particular, satellites in orbit close to the Earth, also referred to as Low Earth Orbit (LEO), are used for this purpose. Such a satellite is connected to a ground-based gateway via a first communication connection, also known as a feeder link. A second communication connection to the mobile terminals of users is referred to as a service link. To provide the second communication link, a corresponding satellite directs one or more communication beams towards a specific area of the Earth. The area covered by such a beam typically has an elliptical peripheral shape and is also referred to as a so-called spot beam. This spot beam can move around the Earth with the satellite. Satellites can also be set up to specifically align the communication beam with respect to the Earth and thus project it into specific target areas. Such satellite-based communication makes it possible to establish a communication connection even in remote regions or where there is limited access to a corresponding mobile network base station.

For a mobile device, the general question arises here as to which communication relay is to be used to connect to the communication network in order to establish or to use the most stable communication connection possible with sufficient signal quality. For this, WO 2020/165675 A1 discloses a method for improved cell selection for non-terrestrial networks. The method provides that a mobile terminal detects one or more metrics of a non-terrestrial network connection and selects a cell of a non-terrestrial network for establishing a communication connection depending on at least one of these metrics. Correspondingly, the mobile terminal locks onto a specific satellite.

Moreover, with the simultaneous availability of terrestrial and non-terrestrial networks, the question also arises as to whether a terrestrial or non-terrestrial communication connection is preferably to be used. Since satellite communication typically involves comparatively increased latency, it can be advantageous to establish a communication connection using a proven method via a ground-based mobile network base station, even though the reception range for a mobile device with respect to a satellite is generally greater than that of a stationary mobile network base station.

This issue is particularly relevant for vehicle manufacturers. More and more competitors are entering the market, providing and offering non-terrestrial network connections. Due to competitive pressure, prices are expected to become increasingly cheaper. Widespread availability and reduced costs lead to the communication connection of vehicles, for example via a vehicle-integrated telematics unit, becoming an option not only for terrestrial network connections but also for non-terrestrial network connections. Since vehicles such as cars and trucks move relatively quickly, establishing and using a stable radio-based communication connection is particularly challenging.

Furthermore, WO 2022/129679 A1 discloses communication in non-terrestrial networks. Here, a device receives a communication signal from a non-terrestrial network node, such as a satellite. The device detects the signal strength and/or signal quality and evaluates it over time. Depending on the extent of the signal strength or signal quality, the device decides whether it is in a state with or without a line of sight to the network node. This information is stored in a database depending on the location.

Exemplary embodiments of the present invention are directed to a method for evaluating the reception quality of a non-terrestrial network connection, by means of which the reception quality can be reliably ascertained or even predicted, even without a corresponding mobile device having to be connected to the non-terrestrial network.

A method for evaluating the reception quality of a non-terrestrial network connection, wherein satellite properties of satellites participating in the non-terrestrial network are collected, is developed according to the invention in that the following method steps are carried out by a vehicle-internal computing unit:
Determining a current holding position of a vehicle;
Determining and/or retrieving satellite properties, wherein the satellite properties include at least orbital coordinates of at least one satellite participating in the non-terrestrial network and beam parameters of the communication beam directed from the satellite to Earth;
Carrying out a position comparison between the holding position of the vehicle and the orbital coordinates of the at least one satellite to determine a line of sight from the vehicle to the at least one satellite;
Detecting the surroundings with the aid of at least one surroundings sensor and determining the extent of surroundings objects at least in the current detection range of the surroundings sensor;
Determining an obstruction of the line of sight from the vehicle to at least one satellite depending on the extent of surrounding objects located within the line of sight;
Evaluating the reception quality, inversely proportional to obstruction.

The method according to the invention allows a vehicle or the vehicle-internal computing unit to reliably estimate the reception quality of a non-terrestrial network connection, even without connecting the communication connection to the non-terrestrial network. Due to surroundings objects such as mountains, hills, trees, high-rise buildings, walls, stone walls and similar, the reception quality of a non-terrestrial network connection can be impaired. If such environmental objects are located within the line of sight between the vehicle and the satellite, then the corresponding surroundings objects shade the satellite for the vehicle, such that data can only be exchanged inadequately. According to the invention, the vehicle determines when and to what extent such shading described by the obstruction occurs and to what extent it affects the reception quality. Here, the vehicle does not necessarily have to connect to the non-terrestrial network, such that an existing communication connection to another communication network can be further maintained. This improves the reliability of the connection of the vehicle to communication networks.

The vehicle can determine its holding position, for example, by means of a navigation system. Here, this can be a global navigation satellite system such as, for example, GPS, Galileo, Beidou, or similar. However, the vehicle can also determine its holding location depending on the data generated by the surroundings sensor(s). For example, characteristic (surroundings) features can be detected in camera images, allowing a position determination.

The satellite properties describe at least orbital coordinates and beam parameters. The orbital coordinates specify, for a specific satellite, when and where the satellite is located relative to the Earth's surface. Here, these can be fixed coordinates or also an orbital orbit. A corresponding satellite can be in a low Earth orbit, a medium Earth orbit, or also a high Earth orbit. It can also be a geostationary satellite. The beam parameters describe at least the orientation of the communication beam generated by the satellite relative to the Earth. Thus, the vehicle-internal computing unit is able to determine when the vehicle is in an area on Earth where a non-terrestrial network connection provided by the respective satellite generally exists, i.e., when the vehicle is located within a respective spot beam. Here, in general, the vehicle can also receive communication beams projected to Earth from multiple satellites simultaneously. The vehicle then determines an individual line of sight for each satellite. Such a line of sight is also referred to as a line of sight (LOS). In particular, taking into consideration the beam parameters, the vehicle can select only those satellites for carrying out the method according to the invention whose communication beam is directed towards the holding position of the vehicle.

The vehicle can use a wide variety of sensors to detect its surroundings, such as mono or stereo cameras, laser scanners such as LiDAR, radar sensors, ultrasonic sensors, and similar. With the help of such surroundings sensors, depth information can be obtained and thus the surroundings can be scanned. Correspondingly, the extent of surroundings objects such as trees, mountains, high-rise buildings, and similar can be determined. In addition to static surroundings objects, dynamic surroundings objects such as other road users can also be detected. The corresponding extents are, in particular, the width and height of a respective surroundings object. Thus, the vehicle is able to determine obstructions located in its field of view (FOV).

If a surroundings object blocks the view of the vehicle of a corresponding satellite, i.e., an obstruction occurs, then the reception quality of the non-terrestrial network connection deteriorates. The more severe the obstruction, the more drastically the reception quality will suffer.

In particular, the computing unit can determine characteristic features of surroundings objects. These characteristic features can be derived, for example, from camera images by means of image recognition algorithms. For example, a characteristic feature might be that the surroundings object is a deciduous tree with leaves on its branches. These leaves block the line of sight to the satellite, but may allow individual data packets to pass through if an existing communication link exists. In contrast to this, if the surroundings object is, for example, a high-rise building, then the communication link to the satellite may collapse completely if the line of sight is blocked.

An advantageous development of the method provides that the reception quality comprises or is formed from a reception probability. Such a reception probability can also be referred to as confidence. The higher the reception probability, the more likely it is that a useable communication connection can be established from the vehicle to the non-terrestrial network. To calculate or to determine the reception probability, a wide variety of variables can be taken into consideration, such as:
The alignment of the communication beam projected by a satellite to Earth, in particular a beam angle;
Radio parameters of the non-terrestrial network or even a terrestrial network;
Measurement reports of the non-terrestrial network or a terrestrial network;
The availability of individual surroundings sensors of the vehicle at the current moment;
The holding position of the vehicle and the orbital coordinates of the satellite;
The extent of the spot beam of a respective satellite in the holding position of the vehicle; and
The number of satellites currently within range, in particular the number of satellites with which there is a line of sight or visual connection.

If there is a line of sight to fewer satellites, then correspondingly a reduced reception probability can be determined, since in the event of an obstruction to the available satellites, there may be no backup satellite within sight with which a communication link can be established. If one or more of the surroundings sensors of the vehicle are unavailable, then surroundings detection may be impaired or even impossible. Correspondingly, surroundings objects can be detected poorly, and in particular, their dimensions can be determined poorly, making it difficult or impossible to determine the obstruction. The reception probability decreases analogously.

Corresponding to a further advantageous design of the method according to the invention, the computing unit controls a mobile radio device inside the vehicle or one coupled to the vehicle in order to switch an active mobile radio connection used by the mobile device between purely terrestrial, purely non-terrestrial, or mixed operation, depending on the reception quality. The mobile device inside the vehicle can, for example, be a telematics unit, also referred to as a telecommunications unit. A mobile device such as a smartphone can also be coupled to the vehicle, for example, wired via a USB cable or wirelessly, for example via NFC, Bluetooth, or Wi-Fi.

The mobile device is capable of establishing both a terrestrial and a non-terrestrial communication connection. This enables purely terrestrial, purely non-terrestrial, or even mixed operation, by a mobile connection existing simultaneously over both the terrestrial network and the non-terrestrial network. The computing unit can then decide which mode to switch to solely taking into consideration the reception quality of the non-terrestrial network connection. In particular with good, i.e. high, reception quality, the computing unit then switches to mixed operation or even purely non-terrestrial operation.

The method according to the invention can thus be used particularly advantageously to select a suitable network connection such that communication for the mobile device can be reliably maintained regardless of the situation.

The computing unit preferably takes into consideration the reception quality of a terrestrial network. The computing unit can then compare the reception quality of the non-terrestrial network connection with the reception quality of the terrestrial network connection and activate the communication connection which has the better reception quality. Thus, there are no predetermined fixed values for the reception quality at which the operating mode is switched; instead, the decision is made depending on the situation. This prevents switching to a terrestrial network if the reception quality for the non-terrestrial network connection is reduced, even if the reception quality of the terrestrial network is also poor. This means that even with reduced reception quality for the non-terrestrial network connection, more reliable communication may still be possible than with a connection to a terrestrial mobile network base station.

Corresponding to a further advantageous design of the method according to the invention, the frequency for determining the reception quality in an urban environment is increased compared to when the vehicle is in non-urban surroundings. In general, the evaluation according to the invention of the reception quality can be carried out continuously. Preferably, the evaluation of the reception quality, i.e., the execution of at least some or all of the steps belonging to the method according to the invention, is carried out discontinuously, i.e., incrementally at discrete time steps. Thus, the detection of sensor data and corresponding processing by the computing unit can be accompanied by certain latencies, which lead to a certain amount of time being required to carry out the individual method steps. With a reduced frequency, i.e., the less frequent execution of the corresponding method steps, the computing resources of the in-vehicle computing unit are available for other tasks or are less heavily used. In a non-urban environment, such as during a cross-country journey, it can be expected that tall surroundings objects that could block the direct line of sight to a satellite, i.e., represent an obstruction, are encountered less frequently. Thus, it is not necessary to frequently recalculate the reception quality. In an urban environment, however, the vehicle is more likely to be in a canyon of buildings, such that high-rise buildings and skyscrapers in particular block the view of the satellites. This increases the dynamics with which the reception quality increases and decreases. Correspondingly, the frequency is advantageously increased such that when driving past corresponding high-rise buildings, it can be quicker to ascertain that the non-terrestrial network connection has high reception quality. For example, the frequency can be increased from 30 Hz to 60 Hz.

A further advantageous design of the method according to the invention further provides that the computing unit generates obstruction data and stores it in a database, in particular, enters it into a digital road map. The obstruction data is information describing the geoposition and extent of surroundings objects. In other words, a map of the surroundings is created. In this map, the surroundings objects are preferably drawn or represented three-dimensionally. With the help of such a database, in particular in the form of a digital road map, predictions can be made as to when and where the line of sight of the vehicle will be shaded by surroundings objects.

Corresponding to a further advantageous design of the method according to the invention, the computing unit determines an upcoming route and predicts the reception quality for the upcoming route. In contrast to a purely live determination of the reception quality, this allows a change of the operating mode to be initiated early on, such that the mobile device can be correspondingly switched to purely terrestrial, purely non-terrestrial, or mixed operation. Determining the upcoming route is possible in various ways. For example, the vehicle can evaluate a navigation route set in a navigation system. However, the vehicle can also determine the route solely by considering the sensor data generated by the surroundings sensors. If, for example, no navigation route is set, then the vehicle can recognize a road ahead and estimate various routes. The route most likely to be taken by the vehicle is then determined as the upcoming route. For this purpose, the steering angle and accelerator pedal position and/or the activation of an indicator can additionally be taken into consideration.

To predict the reception quality for the route, data from live measurements alone can also be used. In particular when the vehicle is travelling on a relatively straight and long road, it is possible to detect surroundings objects at a great distance and to determine their dimensions. Thus, the reception quality can be predicted, for example, when driving past a high-rise building at a distance of 300 meters. However, the previously mentioned database or the digital road map can also be used to predict the reception quality, and the respective obstruction data can be read from it. This enables an even more reliable estimation or prediction of the reception quality, in particular if some or all of the surroundings' sensors are not available at the current moment in time to capture the surroundings with sufficient accuracy.

A further advantageous design of the method according to the invention further provides that the computing unit generates a reception quality map and/or obtains it from an external source and enters the reception quality of the terrestrial network connection and/or the non-terrestrial network connection in the reception quality map. As the vehicle moves through the surroundings, the reception quality of the terrestrial network connection and/or the non-terrestrial network connection can be continuously recorded and plotted, i.e., noted, on the reception quality map. The reception quality map can be maintained within the vehicle or also transmitted externally, for example to a central computing device external to the vehicle, such as a cloud server of a vehicle manufacturer. Thus, the fleet vehicles of the vehicle manufacturer can access the server and always load the most current reception quality map and, if necessary, also update it. Here, it is not necessary to load the entire reception quality map, but only the section of the immediate vicinity in which the vehicle is currently located. Thus, less data needs to be transmitted. With the help of such a reception quality map, the computing unit can estimate even more reliably and earlier when which operating mode should be switched for the mobile device, i.e., purely terrestrial, purely non-terrestrial or mixed operation.

Corresponding to a further advantageous design of the method according to the invention, the computing unit switches the detection behavior of at least one surroundings sensor from a standard mode to an obstruction mode. The surroundings sensors included in the vehicle are typically used for a wide variety of tasks. In particular, static and dynamic surroundings objects are to be detected in order to provide driving functions. These are safety-enhancing driving functions such as lane departure warnings, emergency braking assistance, or adaptive cruise control, as well as convenience functions such as recognizing current traffic signs and displaying them on the display of an instrument cluster. According to the invention, it is necessary to measure the extent of the surroundings objects to determine the obstruction. In particular, the height of the respective surroundings objects is relevant. This means that the surroundings sensors of the vehicle should not only be directed at the section of road immediately ahead, but should preferably detect comparatively high surroundings regions both in close proximity and far away. If the method according to the invention is carried out, for example as soon as the vehicle enters an urban region, then the obstruction mode can be activated. In the obstruction mode, for example, the scanning range of a LiDAR can be changed such that, in particular, the surroundings are scanned with a larger detection angle, such that, for example, a treetop or a house roof can also be detected. Switching between the standard mode and the obstruction mode can occur depending on a variety of events. For example, manual activation or switching is conceivable. Switching can also occur depending on predefined boundary conditions, such as the presence of the vehicle in an urban environment. A further example for automatically switching from the standard mode to the obstruction mode is when, for example, due to fog, splashing water, or a low sun, determining the dimensions of surroundings objects purely based on the camera is no longer possible, such that the sensor data of another sensor is increasingly taken into consideration. Thus, the reliability is increased that the vehicle correctly determines the dimensions of surroundings objects.

In a vehicle comprising at least one surroundings sensor and a computing unit, the surroundings sensor and the computing unit are set up according to the invention to carry out a method described above. In particular, the vehicle comprises an in-vehicle mobile device with functionality for connecting to a non-terrestrial network connection. The vehicle can be any vehicle, such as a passenger car, truck, bus, van, construction machine, or similar. It can also be a rail vehicle, watercraft, or aircraft.

Further advantageous designs of the method according to the invention for evaluating the reception quality of a non-terrestrial network connection and the vehicle also emerge from the exemplary embodiments, which are described in more detail below with reference to the Figures.

### BRIEF DESCRIPTION OF THE DRAWING FIGURES

Here are shown in:

FIG. 1 a schematic depiction of a vehicle according to the invention, which carries out a method according to the invention for evaluating the reception quality of a non-terrestrial network connection;

FIG. 2 a schematic depiction of the vehicle shown in FIG. 1 in a first situation; and

FIG. 3 a schematic depiction of the vehicle shown in FIG. 1 in a second situation.

### DETAILED DESCRIPTION

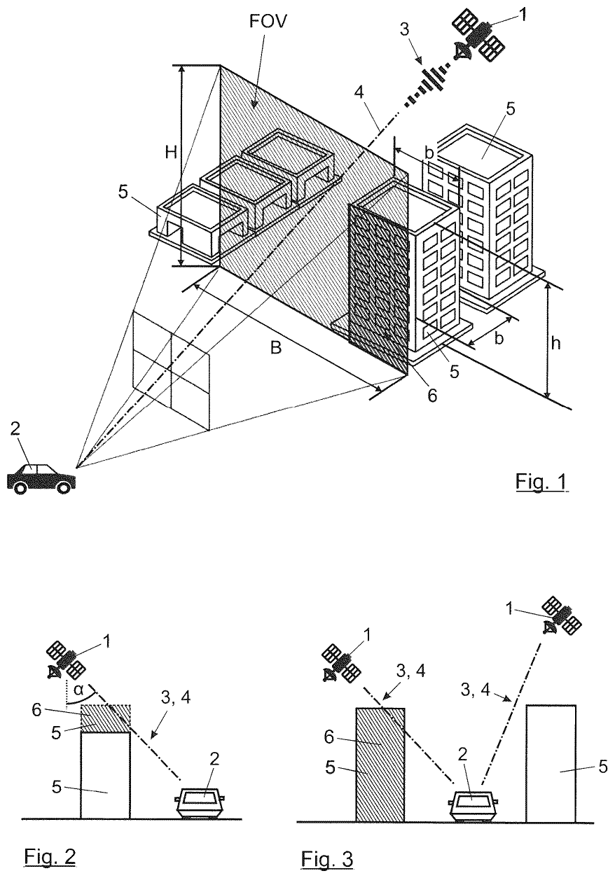

FIG. 1 shows a vehicle 2 travelling on a road in an urban environment. The vehicle 2 has an in-vehicle mobile device in the form of a telematics unit. The telematics unit is capable of establishing a communication connection via both a terrestrial network and a non-terrestrial network. Such a non-terrestrial network is provided by means of satellites 1. For this purpose, a corresponding satellite 1 directs a communication beam 3 toward specific regions of the Earth to provide network coverage.

A direct connection line, referred to here as line of sight 4, between vehicle 2 and satellite 1, can be blocked by surroundings objects 5. Such an obstruction is also referred to as an obstruction 6.

If an obstruction 6 is present within the line of sight 4, then the reception quality of the non-terrestrial network connection suffers.

The vehicle 2 shown in FIG. 1 carries out a method according to the invention for evaluating the reception quality of the non-terrestrial network connection. To do so, the vehicle 2 first determines its current holding location. An in-vehicle computing unit then determines satellite properties and/or retrieves them from a source external to the vehicle, such as a service provider. Here, the satellite properties describe at least the orbital coordinates of satellite 1 and beam parameters of the communication beam 3 directed from the satellite 1 to Earth. The in-vehicle computing unit then carries out a position comparison between the holding position of the vehicle 2 and the orbital coordinates of the satellite 1 to determine the line of sight 4. In particular, here the computing unit takes into consideration the orientation of the communication beam 3 based on the beam parameters.

The vehicle detects its surroundings by means of surroundings sensors. This makes it possible to detect the surrounding objects 5, here in the form of houses or high-rise buildings, and to determine their dimensions b, h, i.e., their width and height, for example. This makes it possible for the vehicle 2 to determine said obstruction 6 in a reception region FOV defined by the height H and the width B, also known as the field of view.

The in-vehicle computing unit then evaluates the reception quality inversely proportional to the obstruction 6. The larger the obstruction 6, i.e., the more the line of sight 4 between vehicle 2 and satellite 1 is shaded, the lower the reception quality is assumed to be. For example, the severity of obstruction 6 can be evaluated as a proportion of the area of the reception region FOV. Thus, if the entire reception region FOV is assumed by an obstruction 6, a maximum obstruction 6 exists.

Here, FIG. 2 shows a view from behind of the vehicle 2. Here, the communication beam 3 is directed from the satellite 1 toward the Earth at a specific angle a. If a corresponding high-rise building is small enough, then the line of sight 4 or the communication beam 3 is not shaded. However, if the building is too tall, then the communication beam 3 or the line of sight 4 is shaded by the obstruction 6, as indicated by a dark hatched area, such that the reception quality is reduced or even a stable communication connection to the satellite 1 cannot be established.

FIG. 3 shows a further situation in which a line of sight 4 to several satellites 1, here two satellites 1, exists simultaneously. If the line of sight 4 to one of the satellites 1 is interrupted by a surroundings object 5 or an obstruction 6, then a communication connection can be established instead with a satellite 1 to which a continuous, i.e., uninterrupted line of sight 4 exists. Thus, it can be reliably achieved that a stable communication connection for the mobile device included in the vehicle can be established. Instead of an in-vehicle mobile device, a mobile device coupled to the vehicle 2, such as a smartphone, for example, can also be used.

In particular, the in-vehicle computing unit changes an operating mode of the mobile device depending on the reception quality. Thus, the computing unit switches the mobile device between purely terrestrial, purely non-terrestrial, or mixed operation. This ensures the reliable and permanent provision of a stable communication connection. For this purpose, the reception quality of the non-terrestrial network connection can be taken into consideration exclusively, or alternatively, in relation to the reception quality of a terrestrial network connection. The reception quality of the terrestrial network connection can be determined using a proven, conventional method.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method comprising:
determining, by an in-vehicle computing unit of a vehicle, a current holding position of the vehicle;
determining or retrieving, by the in-vehicle computing unit, satellite properties, wherein the satellite properties include at least orbital coordinates of at least one satellite participating in a non-terrestrial network and beam parameters of a communication beam directed from the at least one satellite to Earth;
determining, by the in-vehicle computing unit, a line of sight from the vehicle to the at least one satellite using a position comparison between the holding position of the vehicle and the orbital coordinates of the at least one satellite;
detecting, by the in-vehicle computing unit using at least one surroundings sensor, objects in surroundings of the vehicle;
determining, by the in-vehicle computing unit, an extent of the detected objects in the surroundings of the vehicle at least in a current detection region of the at least one surroundings sensor;
determining, by the in-vehicle computing unit, an obstruction of the line of sight from the vehicle to the at least one satellite depending on the extent of surrounding objects located within the line of sight; and
evaluating, by the in-vehicle computing unit, reception quality of a non-terrestrial connection between the vehicle and the non-terrestrial network inversely proportional to the obstruction of the line of sight from the vehicle to the at least one satellite.

12. The method of claim 11, wherein the reception quality comprises a reception probability or the reception quality if formed from the reception probability.

13. The method of claim 11, further comprising:
controlling, by the in-vehicle the computing unit, a mobile device inside the vehicle or coupled to the vehicle to switch, depending on the reception quality, an active mobile connection used by the mobile device between a purely terrestrial operation, a purely non-terrestrial operation, or a mixed operation of terrestrial and non-terrestrial operation.

14. The method of claim 13, further comprising:
determining, by the in-vehicle computing unit, a reception quality of a terrestrial network connection, wherein the in-vehicle computing unit considers the reception quality of the terrestrial network for the controlling of the mobile device to switch the active mobile connection.

15. The method of claim 11, wherein a frequency for the evaluating of the reception quality when the vehicle is in urban surroundings is increased compared to when the vehicle is in non-urban surroundings.

16. The method of claim 11, further comprising:
generating, by the in-vehicle computing unit, obstruction data; and
storing, by the in-vehicle computing unit, the obstruction data in a database.

17. The method of claim 11, further comprising:
determining, by the in-vehicle computing unit, a road ahead of the vehicle; and
predicting, by the in-vehicle computing unit, reception quality for the road ahead.

18. The method of claim 14, further comprising:
generating or obtaining from an external source, by the in-vehicle computing unit, a reception quality map; and
entering, by the in-vehicle computing unit, the reception quality of the terrestrial network connection or the non-terrestrial network connection in the reception quality map.

19. The method of claim 11, further comprising:
switching, by the in-vehicle computing unit, detection behavior of at least one surroundings sensor from a standard mode to an obstruction mode.

20. A vehicle comprising:
at least one surroundings sensor; and
a computing unit coupled to the at least one surroundings sensor and configured to
determine a current holding position of the vehicle;
determine or retrieve satellite properties, wherein the satellite properties include at least orbital coordinates of at least one satellite participating in a non-terrestrial network and beam parameters of a communication beam directed from the at least one satellite to Earth;
determine a line of sight from the vehicle to the at least one satellite using a position comparison between the holding position of the vehicle and the orbital coordinates of the at least one satellite;
detect, using the at least one surroundings sensor, objects in surroundings of the vehicle;
determine an extent of the detected objects in the surroundings of the vehicle at least in a current detection region of the at least one surroundings sensor;
determine an obstruction of the line of sight from the vehicle to the at least one satellite depending on the extent of surrounding objects located within the line of sight; and
evaluate reception quality of a connection between the vehicle and the non-terrestrial network inversely proportional to the obstruction of the line of sight from the vehicle to the at least one satellite.
